(19) United States
(12) Patent Application Publication
(10) Pub. No.: US 2026/0008071 A1
(43) Pub. Date: Jan. 8, 2026

(54) AEROSOL VALVE AND AEROSOL SPRAY APPARATUS

(71) Applicant: Majesty Holdings Co., Ltd., Zhongshan, Guangdong (CN)

(72) Inventors: Peihui LIANG, Zhongshan (CN); Jun Li, Zhongshan (CN); Yonglei ZHANG, Zhongshan (CN); Maoyong Zhu, Zhongshan (CN)

(73) Assignee: Majesty Holdings Co.,Ltd., Zhongshan, Guangdong (CN)

(21) Appl. No.: 18/863,595

(22) PCT Filed: Sep. 22, 2023
(86) PCT No.: PCT/CN2023/120562

§ 371 Date: Nov. 6, 2024

(30) Foreign Application Priority Data
Aug. 14, 2023 (CN) 202311024387.X

(51) Int. Cl. B05B 7/04

(52) U.S. Cl. CPC B05B 7/0483

(57) ABSTRACT

Disclosed are an aerosol valve and an aerosol spray apparatus, the aerosol valve being applied to the aerosol spray apparatus. The aerosol valve includes a valve body connected to a sealing cup, the valve body is arranged with a valve cavity for liquid in an aerosol tank to enter, a valve stem is slidably provided up and down in the valve cavity with an upper end penetrating through the sealing cup, a spray cavity is arranged on the valve stem, a gas intake structure enabling compressed gas in the aerosol tank to enter the spray cavity and a liquid intake structure enabling the liquid in the aerosol tank from the valve cavity to enter the spray cavity when the valve stem slides downwards is provided between the valve body and the valve stem, and a flow guide structure is provided in the spray cavity, for guiding the liquid and the compressed gas to mix and flow out of the spray cavity. The aerosol spray apparatus includes an aerosol tank with a tank opening, and an actuator plugged into an upper end of the valve stem and capable of spraying liquid in a mist form; the tank opening of the aerosol tank is provided with a convex edge, and the sealing cup is provided with a connecting flange that is buckled on the convex edge to fix the aerosol valve on the aerosol tank.

### FIELD OF THE INVENTION

The present disclosure relates to the technical field of aerosol products, and in particular to an aerosol valve and an aerosol spray apparatus using the aerosol valve.

### BACKGROUND OF THE INVENTION

In the development of the aerosol industry over more than half a century, it has faced two significant setbacks. The first occurred in the 1970s and extended until the mid-1980s, culminating in the 1987 Montreal Protocol. This protocol definitively prohibits the use of chlorofluorocarbons (CFCs) in aerosols. As substitutes, petrochemical gases, predominantly liquefied petroleum gas (LPG) and dimethyl ether (DME), emerged as new spray power sources for aerosols. In the subsequent second setback, there was controversy surrounding the reduction and limitation of using volatile organic compounds (VOCs) in aerosols, as LPG and DME are also VOCs and may ultimately face replacement. Compressed gases such as air, nitrogen, and carbon dioxide have advantages such as no damage to the ozone layer and the entire ecological environment, and are non-flammable, making them preferable propellant substitutes following the two setbacks in the aerosol industry.

Currently, in an aerosol tank using compressed gas as a propellant, the aerosol valve typically only allows the compressed gas to squeeze the liquid flow from the tank out and spray it onto the actuator, followed by atomization through the actuator nozzle. The structure of such aerosol valve is disclosed in a Chinese patent application number CN201620896344.X, which is entitled a powder spraying type aerosol valve structure. It usually includes a valve body connected to a sealing cup, with a valve stem positioned in a cavity within the valve body. One end of the valve stem penetrates through the sealing cup and the valve body, with an inner sealing gasket being pressed between the end of the valve body and the inner wall of the sealing cup. The inner sealing gasket sleeves one end of the valve stem and forms a movable seal with the valve stem. The valve stem has a liquid spraying cavity at one end and a flow limiting hole in the middle. The inner wall of the cavity of the valve body and the outer wall of the valve stem together enclose a liquid spraying gap. By regulating the communication between the flow limiting hole in the liquid spraying channel and the liquid spraying gap, the liquid spraying of this product can be controlled. However, compressed gas typically lacks the “liquid vaporization” effect, meaning it does not rapidly vaporize liquid like liquefied gas during discharge from an aerosol spray device. The rapid expansion of the vaporization usually results in the formation of a fine spray. Since the above aerosol valve cannot achieve atomization on its own, when compressed gas is used as the propellant, aerosol products with previous aerosol valves often encounter issues such as larger spray particle sizes and inferior atomization effects.

Therefore, the present disclosure is just produced based on the above shortcomings.

### SUMMARY OF THE INVENTION

An object of the present disclosure is to overcome the disadvantages of the prior art and to provide an aerosol valve with a simple structure and an improved atomization effect, and an aerosol spray apparatus using the aerosol valve.

The present disclosure is achieved by the following technical solution:

An aerosol valve includes a valve body 2 connected to a sealing cup 1, where the valve body 2 is arranged with a valve cavity 21 for liquid in an aerosol tank to enter, a valve stem 3 is slidably provided up and down in the valve cavity 21 with an upper end penetrating through the sealing cup 1, a spray cavity 31 is arranged on the valve stem 3, a gas intake structure 4 enabling compressed gas in the aerosol tank to enter the spray cavity 31 and a liquid intake structure 5 enabling the liquid in the aerosol tank from the valve cavity 21 to enter the spray cavity 31 when the valve stem 3 slides downwards is provided between the valve body 2 and the valve stem 3, and a flow guide structure 6 is provided in the spray cavity 31, for guiding the liquid and the compressed gas to mix and flow out of the spray cavity 31.

For the above aerosol valve, the gas intake structure 4 and the liquid intake structure 5 are arranged opposite to each other; the flow guide structure 6 includes a gas guide surface 61 arranged on one side of the gas intake structure 4 and capable of guiding the compressed gas into a vortex shape, and a liquid guide surface 62 arranged on one side of the liquid intake structure 5 and capable of guiding the liquid into a vortex shape, and the vortex-shaped compressed gas and the vortex-shaped liquid have a same rotation direction so that the compressed gas and the liquid are mixed in a vortex shape.

For the above aerosol valve, the flow guide structure 6 is a convex block in the middle of the bottom wall of the spray cavity 31, an outer wall of the convex block is spaced from an inner wall of the spray cavity 31, and the gas guide surface 61 and the liquid guide surface 62 are arranged on two sides of the convex block, respectively.

For the above aerosol valve, the gas guide surface 61 includes a first arc concave surface directly opposite to the gas intake structure 4 and a first arc convex surface connected to the first arc concave surface, and the liquid guide surface 62 includes a second arc concave surface directly opposite to the liquid intake structure 5 and a second arc convex surface connected to the second arc concave surface.

For the above aerosol valve, the gas intake structure 4 includes a gas intake hole 41 provided on a side wall of the valve body 2 for the compressed gas in the aerosol tank to enter, and a gas jet 42 provided on a side wall of the valve stem 3 and communicating the gas intake hole 41 and the spray cavity 31 when the valve stem 3 slides downwards.

For the above aerosol valve, the gas intake hole 41 includes a large gas intake hole end 411 for the compressed gas to enter and a small gas intake hole end 412 for communicating the large gas intake hole end 411 and the gas jet 42 and having a smaller diameter than the large gas intake hole end 411.

For the above aerosol valve, the liquid intake structure 5 includes a liquid jet 52 provided on the side wall of the valve stem 3 and communicating the valve cavity 21 and the spray cavity 31 when the valve stem 3 slides downwards.

For the above aerosol valve, the gas jet 42 and the liquid jet 52 each include an inlet section, an outlet section having a smaller diameter than the inlet section and communicating with the spray cavity 31, and a transition section connected between the inlet section and the outlet section and having a diameter gradually decreasing from the inlet section to the outlet section.

For the above aerosol valve, a sealing gasket 8 movably and sealingly sleeving the valve stem 3 is mounted between the valve body 2 and the sealing cup 1, the gas jet 42 and the liquid jet 52 are located above the sealing gasket 8; when the valve stem 3 slides downwards, the gas jet 42 moves below the sealing gasket 8 to communicate with the gas intake hole 41, and the liquid jet 52 moves below the sealing gasket 8 to communicate with the valve cavity 21; and a spring 9 capable of springing the valve stem 3 to reset upwards is provided in the valve cavity 21.

An aerosol spray apparatus using the above aerosol valve includes an aerosol tank 20 with a tank opening, and an actuator 30 plugged into an upper end of the valve stem 3 and capable of spraying liquid in a mist form, where the tank opening of the aerosol tank 20 is provided with a convex edge 201, and the sealing cup 1 is provided with a connecting flange 12 that is buckled on the convex edge 201 to fix the aerosol valve on the aerosol tank 20.

Compared to the prior art, the present disclosure has the following advantages:

1. In the present disclosure, the compressed gas entering the spray cavity from the gas intake structure and the liquid entering the spray cavity from the liquid intake structure is guided by the flow guide structure to form a two-phase flow, so that the airflow mixes and impacts the liquid to break up the liquid. The structure is simple, and preliminary atomization can be performed before the actuator is used for atomization, thereby improving the atomization effect, meeting the atomization requirements of using compressed gas as a propellant and being beneficial to environmental protection.

2. In the present disclosure, the compressed gas passes through the gas intake holes with apertures from large to small, and the gas flow rate increases, which is convenient for breaking up the liquid.

### BRIEF DESCRIPTION OF THE DRAWINGS

FIG. 1 is a perspective view of the present disclosure;

FIG. 2 is a cross-sectional view of the present disclosure in an initial state;

FIG. 3 is a cross-sectional view of the present disclosure in a use state;

FIG. 4 is a cross-sectional view at A-A in FIG. 3;

FIG. 5 is an exploded view of the present disclosure; and

FIG. 6 is a structural diagram of an aerosol spray apparatus equipped with an aerosol valve of the present disclosure.

### DETAILED DESCRIPTION OF THE EMBODIMENTS

The present disclosure will now be further described concerning the drawings:

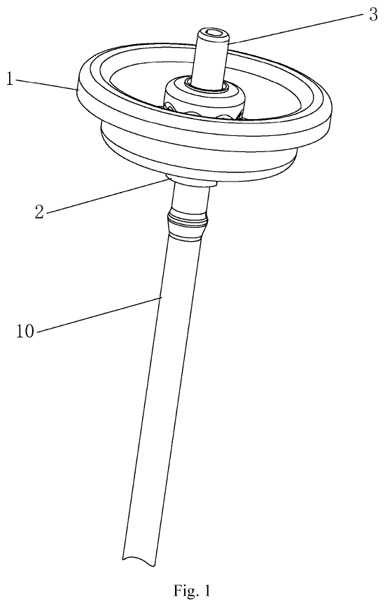

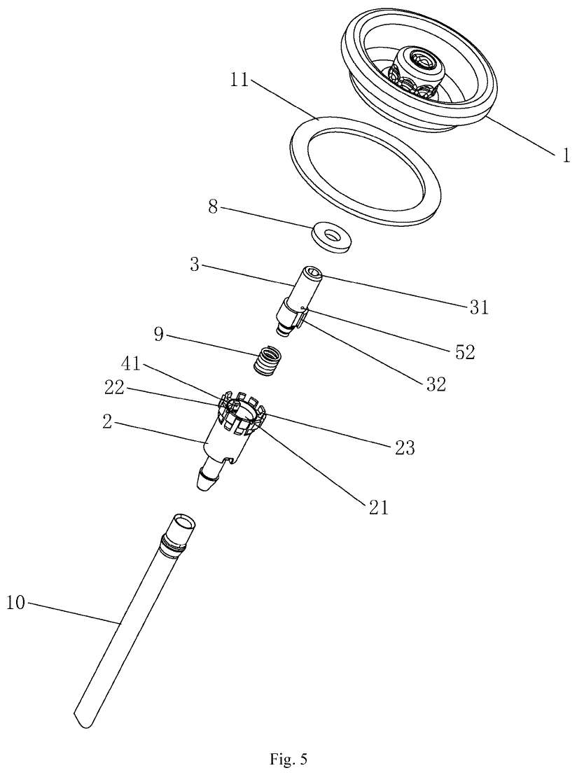

As shown in FIGS. 1 to 6, an aerosol valve includes a valve body 2 connected to a sealing cup 1, where the valve body 2 is arranged with a valve cavity 21 for liquid in an aerosol tank to enter, a valve stem 3 is slidably provided up and down in the valve cavity 21 with an upper end penetrating through the sealing cup 1, a spray cavity 31 is arranged on the valve stem 3, a gas intake structure 4 enabling compressed gas in the aerosol tank to enter the spray cavity 31 and a liquid intake structure 5 enabling the liquid in the aerosol tank from the valve cavity 21 to enter the spray cavity 31 when the valve stem 3 slides downwards is provided between the valve body 2 and the valve stem 3, and a flow guide structure 6 is provided in the spray cavity 31, for guiding the liquid and the compressed gas to mix and flow out of the spray cavity 31. In the present disclosure, the compressed gas entering the spray cavity from the gas intake structure and the liquid entering the spray cavity from the liquid intake structure is guided by the flow guide structure to form a two-phase flow, so that the airflow mixes and impacts the liquid to break up the liquid. The structure is simple, and preliminary atomization can be performed before the actuator is used for atomization, thereby improving the atomization effect, meeting the atomization requirements of using compressed gas as a propellant and being beneficial to environmental protection.

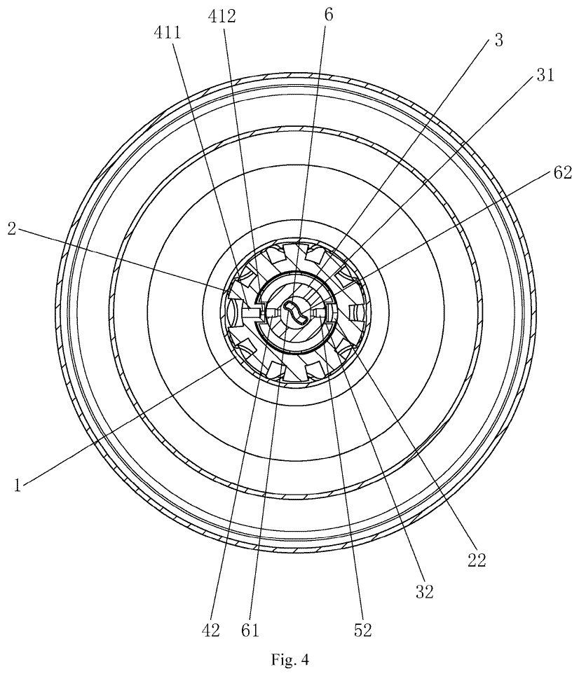

As shown in FIG. 4, the gas intake structure 4 and the liquid intake structure 5 are arranged opposite to each other; the flow guide structure 6 includes a gas guide surface 61 arranged on one side of the gas intake structure 4 and capable of guiding the compressed gas into a vortex shape, and a liquid guide surface 62 arranged on one side of the liquid intake structure 5 and capable of guiding the liquid into a vortex shape, and the vortex-shaped compressed gas and the vortex-shaped liquid have a same rotation direction so that the compressed gas and the liquid are mixed in a vortex shape.

Specifically, the flow guide structure 6 is a convex block in the middle of the bottom wall of the spray cavity 31, an outer wall of the convex block is spaced from an inner wall of the spray cavity 31, and the gas guide surface 61 and the liquid guide surface 62 are arranged on two sides of the convex block, respectively.

Specifically, the gas guide surface 61 includes a first arc concave surface directly opposite to the gas intake structure 4 and a first arc convex surface connected to the first arc concave surface, and the liquid guide surface 62 includes a second arc concave surface directly opposite to the liquid intake structure 5 and a second arc convex surface connected to the second arc concave surface. The flow guide structure 6 is approximately an S-shaped block.

The gas intake structure 4 includes a gas intake hole 41 provided on a side wall of the valve body 2 for the compressed gas in the aerosol tank to enter, and a gas jet 42 provided on a side wall of the valve stem 3 and connecting the gas intake hole 41 and the spray cavity 31 when the valve stem 3 slides downwards; the liquid intake structure 5 includes a liquid jet 52 provided on the side wall of the valve stem 3 and communicating the valve cavity 21 and the spray cavity 31 when the valve stem 3 slides downwards. The gas jet 42 and the liquid jet 52 are provided on two sides of the flow guide structure 6, the gas jet 42 is directly opposite to the first arc concave surface of the gas guide surface 61, and the liquid jet 52 is directly opposite to the second arc concave surface of the liquid guide surface 62. When the gas intake hole 41 is in communication with the gas jet 42, and the valve cavity 21 is in communication with the liquid jet 52, the compressed gas and the liquid are respectively sprayed to the two sides of the flow guide structure 6, and flow along the approximately S-shaped guide surfaces of the flow guide structure 6 at the two sides of the flow guide structure 6, and are finally interleaved into a two-phase vortex.

Further, the gas intake hole 41 includes a large gas intake hole end 411 for the compressed gas to enter and a small gas intake hole end 412 for communicating the large gas intake hole end 411 and the gas jet 42 and having a smaller diameter than the large gas intake hole end 411. The above structure can control the gas intake flow rate; the compressed gas passes through the gas intake holes with apertures from large to small, and the gas flow rate increases, which is convenient for breaking up the liquid.

Further, the gas jet 42 and the liquid jet 52 each include an inlet section, an outlet section having a smaller diameter than the inlet section and communicating with the spray cavity 31, and a transition section connected between the inlet section and the outlet section and having a diameter gradually decreasing from the inlet section to the outlet section. After the fluid passes through the gas jet 42 and the liquid jet 52 with a transitional aperture from large to small, the flow rate of the gas and liquid entering the spray cavity 31 increases, which is more conducive to breaking up the liquid, thereby making the ejected aerosol product more finely atomized and more uniform.

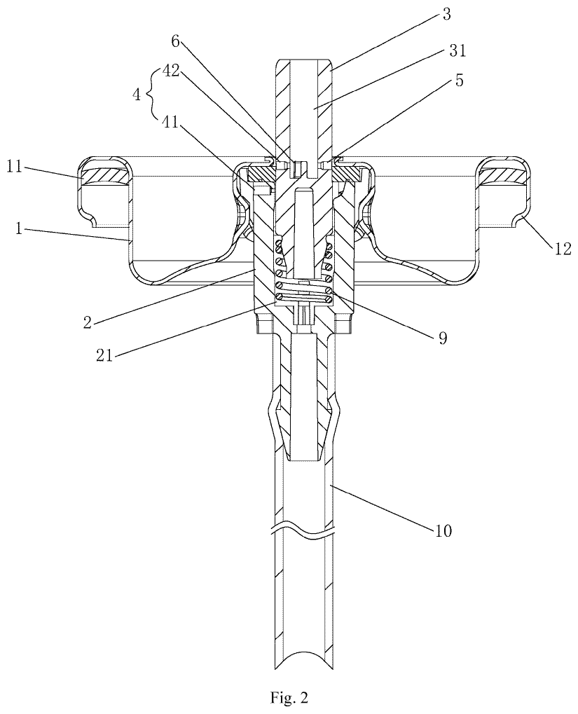

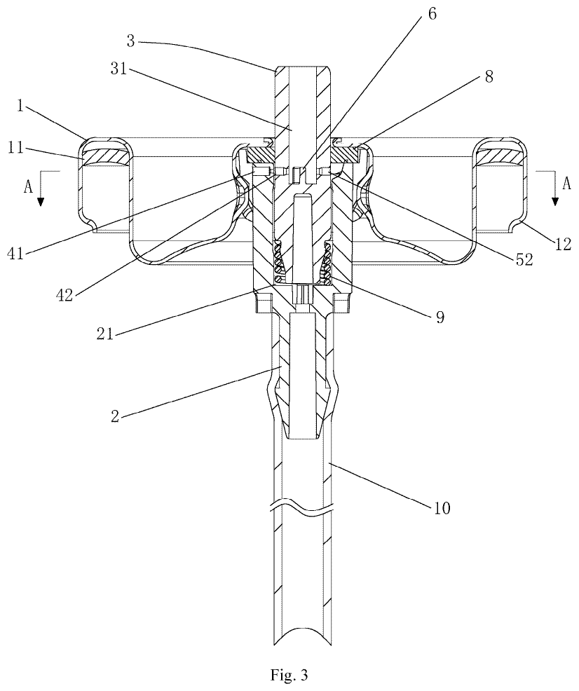

In the present disclosure, a sealing gasket 8 movably and sealingly sleeving the valve stem 3 is mounted between the valve body 2 and the sealing cup 1. The sealing gasket 8 is specifically mounted in the mounting groove 23 at the end of the valve body 2 and is clamped between the valve body 2 and the sealing cup 1 after the valve body 2 is clamped on the sealing cup 1. As shown in FIG. 2, in the initial state, the gas jet 42 and the liquid jet 52 are located above the sealing gasket 8, separated from the gas intake hole 41 and the valve cavity 21; as shown in FIG. 3, when the valve stem 3 slides downwards, the gas jet 42 moves below the sealing gasket 8 to communicate with the gas intake hole 41, and the liquid jet 52 moves below the sealing gasket 8 to communicate with the valve cavity 21; and a spring 9 capable of springing the valve stem 3 to reset upwards is provided in the valve cavity 21. The lower end of the spring 9 abuts the bottom wall of the valve cavity 21 and the upper end abuts the lower end of the valve stem 3. When the valve stem 3 slides downwards to eject the two-phase flow, the spring 9 can spring the valve stem 3 reset upwards so that the gas jet 42 and the liquid jet 52 are located above the sealing gasket 8, so that the aerosol valve is resealed.

In the present disclosure, the valve stem 3 is arranged with guide grooves 32 extending longitudinally, and the valve cavity 21 is provided with guide sliders 22 each inserted into the guide grooves 32 and sliding along the guide grooves 32 when the valve stem 3 slides up and down relative to the valve body 2. Specifically, two guide sliders 22 are provided on the inner wall of the valve cavity 21, and correspondingly, guide grooves 32 are arranged on two sides of the outer peripheral wall of the valve stem 3. When the valve stem 3 slides up and down relative to the valve body 2, the guide grooves 32 and the guide sliders 22 play a sliding guide role for the valve stem 3, so that the valve stem slides stably without dislocation, ensuring that the gas intake structure and the liquid intake structure operate smoothly.

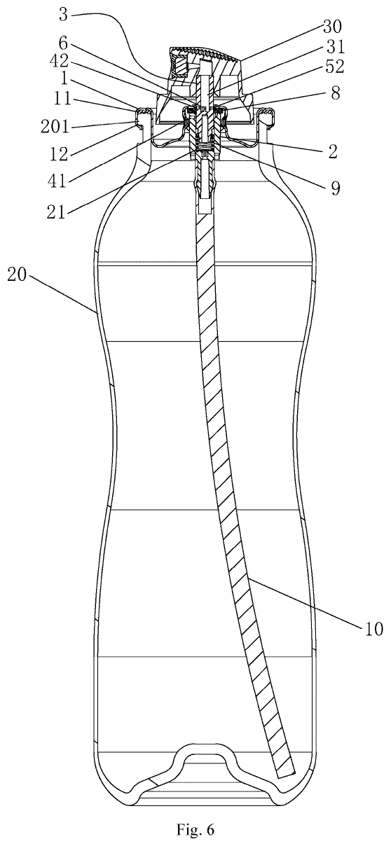

As shown in FIG. 6, an aerosol spray apparatus using the above aerosol valve includes an aerosol tank 20 with a tank opening, and an actuator 30 plugged into an upper end of the valve stem 3 and capable of spraying liquid in a mist form. The actuator 30 adopts a two-piece precision mist point structure, which is assembled from a mist point main body apparatus and a mist point diversion positioning column apparatus. The atomized particles are fine, the spray is soft, and the noise is low. For the structure and principle of the mist point structure, reference can be made to the Chinese patent previously applied by our company, with application number CN201510036877.0, and the patent name is a two-piece precision mist point; the tank opening of the aerosol tank 20 is provided with a convex edge 201, and the sealing cup 1 is provided with a connecting flange 12 that is buckled on the convex edge 201 to fix the aerosol valve on the aerosol tank 20. Specifically, a sealing cup gasket 11 is provided in the sealing cup 1. When the connecting flange 12 cooperates with the convex edge 201 to mount the sealing cup 1 on the aerosol tank 20, the sealing cup 1 presses the sealing cup gasket 11 against the end of the tank opening of the aerosol tank 20, thereby achieving a fixed seal between the sealing cup 1 and the aerosol tank 20; a straw 10 is connected to the liquid inlet at the lower end of the valve body 2, and the straw 10 extends into the aerosol tank 20. Since the gas phase is at the upper part of the tank body and the liquid phase is at the lower part of the tank body in the aerosol tank, when the aerosol valve is mounted on the aerosol tank 20 and used, the liquid enters the valve cavity 21 from the straw 10 and then is sprayed into the spray cavity 31 through the liquid jet 52, while the gas enters from the gas intake hole 41 and is sprayed into the spray cavity 31 through the gas jet 42. The compressed gas and the liquid are sprayed onto two sides of the S-shaped block, respectively, flow along the S-shaped block on the two sides of the S-shaped block, and finally interweave into a two-phase vortex, and the air flow mixes and impacts to break up the liquid. Finally, when the actuator is sprayed, the spray particle size is small and the atomization effect is good.

1. An aerosol valve, comprising a valve body (2) connected to a sealing cup (1), wherein the valve body (2) is arranged with a valve cavity (21) for liquid in an aerosol tank to enter, a valve stem (3) is slidably provided up and down in the valve cavity (21) with an upper end penetrating through the sealing cup (1), a spray cavity (31) is arranged on the valve stem (3), a gas intake structure (4) enabling compressed gas in the aerosol tank to enter the spray cavity (31) and a liquid intake structure (5) enabling the liquid in the aerosol tank from the valve cavity (21) to enter the spray cavity (31) when the valve stem (3) slides downwards is provided between the valve body (2) and the valve stem (3), and a flow guide structure (6) is provided in the spray cavity (31), for guiding the liquid and the compressed gas to mix and flow out of the spray cavity (31).

2. The aerosol valve according to claim 1, wherein the gas intake structure (4) and the liquid intake structure (5) are arranged opposite to each other; the flow guide structure (6) comprises a gas guide surface (61) arranged on one side of the gas intake structure (4) and capable of guiding the compressed gas into a vortex shape, and a liquid guide surface (62) arranged on one side of the liquid intake structure (5) and capable of guiding the liquid into a vortex shape, and the vortex-shaped compressed gas and the vortex-shaped liquid have a same rotation direction so that the compressed gas and the liquid are mixed in a vortex shape.

3. The aerosol valve according to claim 2, wherein the flow guide structure (6) is a convex block in the middle of the bottom wall of the spray cavity (31), an outer wall of the convex block is spaced from an inner wall of the spray cavity (31), and the gas guide surface (61) and the liquid guide surface (62) are arranged on two sides of the convex block, respectively.

4. The aerosol valve according to claim 2, wherein the gas guide surface (61) comprises a first arc concave surface directly opposite to the gas intake structure (4) and a first arc convex surface connected to the first arc concave surface, and the liquid guide surface (62) comprises a second arc concave surface directly opposite to the liquid intake structure (5) and a second arc convex surface connected to the second arc concave surface.

5. The aerosol valve according to claim 1, wherein the gas intake structure (4) comprises a gas intake hole (41) provided on a side wall of the valve body (2) for the compressed gas in the aerosol tank to enter, and a gas jet (42) provided on a side wall of the valve stem (3) and communicating the gas intake hole (41) and the spray cavity (31) when the valve stem (3) slides downwards.

6. The aerosol valve according to claim 5, wherein the gas intake hole (41) comprises a large gas intake hole end (411) for the compressed gas to enter, and a small gas intake hole end (412) for communicating the large gas intake hole end (411) and the gas jet (42) and having a smaller diameter than the large gas intake hole end (411).

7. The aerosol valve according to claim 5, wherein the liquid intake structure (5) comprises a liquid jet (52) provided on the side wall of the valve stem (3) and communicating the valve cavity (21) and the spray cavity (31) when the valve stem (3) slides downwards.

8. The aerosol valve according to claim 7, wherein the gas jet (42) and the liquid jet (52) each comprise an inlet section, an outlet section having a smaller diameter than the inlet section and communicating with the spray cavity (31), and a transition section connected between the inlet section and the outlet section and having a diameter gradually decreasing from the inlet section to the outlet section.

9. The aerosol valve according to claim 7, wherein a sealing gasket (8) movably and sealingly sleeving the valve stem (3) is mounted between the valve body (2) and the sealing cup (1), the gas jet (42) and the liquid jet (52) are located above the sealing gasket (8); when the valve stem (3) slides downwards, the gas jet (42) moves below the sealing gasket (8) to communicate with the gas intake hole (41), and the liquid jet (52) moves below the sealing gasket (8) to communicate with the valve cavity (21); and a spring (9) capable of springing the valve stem (3) to reset upwards is provided in the valve cavity (21).

10. An aerosol spray apparatus using the aerosol valve according to claim 1, comprising an aerosol tank (20) with a tank opening, and an actuator (30) plugged into an upper end of the valve stem (3) and capable of spraying liquid in a mist form, wherein the tank opening of the aerosol tank (20) is provided with a convex edge (201), and the sealing cup (1) is provided with a connecting flange (12) that is buckled on the convex edge (201) to fix the aerosol valve on the aerosol tank (20).
